(19) United States
(12) Patent Application Publication
(10) Pub. No.: US 2023/0401468 A1
(43) Pub. Date: Dec. 14, 2023

(54) METHODS AND SYSTEMS FOR GENERATING FORECASTS USING AN ENSEMBLE ONLINE DEMAND GENERATION FORECASTER

(71) Applicant: Dell Products L.P., Round Rock, TX (US)

(72) Inventors: Arun Kumar Venkitaraman, Bangalore (IN); Renold Raj Devaraj, Bangalore (IN)

(21) Appl. No.: 17/746,710

(22) Filed: May 17, 2022

(51) Int. Cl. G06N 7/00; G06K 9/62

(52) U.S. Cl. CPC G06N 7/005; G06K 9/6262; G06K 9/6253

(57) ABSTRACT

A method for generating final prediction data, that includes generating, by a prediction generator, validation prediction data using a prediction model, making a first determination that the validation prediction data includes unexplained variance data, in response to making the first determination, isolating unexplained variance data from the validation prediction data, generating initial prediction data using the prediction model, isolating prediction trend data from the initial prediction data, obtaining the final prediction data by summing the prediction trend data with the unexplained variance data, receiving, from a user, a constraint, making a second determination that the final prediction data satisfies the constraint, and based on the second determination, indicating, to the user, that the final prediction data satisfies the constraint.

### BACKGROUND

Devices and/or components of devices are often capable of performing certain functionalities that other devices and/or components are not configured to perform and/or are not capable of performing. In such scenarios, it may be desirable to adapt one or more systems to enhance the functionalities of devices and/or components that cannot perform the one or more functionalities.

### BRIEF DESCRIPTION OF DRAWINGS

FIG. 1A shows a diagram of a system, in accordance with one or more embodiments.

FIG. 1B shows a diagram of various data, in accordance with one or more embodiments.

FIG. 2 shows a flowchart of generating prediction data, in accordance with one or more embodiments.

FIG. 3 shows a flowchart of identifying a most suitable final prediction dataset, in accordance with one or more embodiments.

### DETAILED DESCRIPTION

In general, embodiments relate to systems and methods for semi-automatically generating prediction data to produce more accurate forecasts. Conventional techniques for generating prediction data (e.g., for use in marketing, sales, demand forecasts) rely heavily on the assumption that past events will continue to repeat in the future with a high degree of similarity. One reason for the over-reliance on historical data (where it is assumed many variables will remain constant) is that the impact and interplay of certain predictor variables (e.g., market factors, product pricing, seasonality, trends, market conditions, key performance indicator(s), etc.) are difficult to parse from the historical data and are therefore left constant in the prediction data. As a result, the accuracy of the forecast suffers as the underlying prediction model is too inflexible to produce accurate prediction data. Further, such forecasts are often expensive to produce as considerable manual effort is required to obtain, aggregate, and analyze the historical data.

As described in one or more embodiments herein, more accurate forecasts may be produced by first generating prediction models using one or more machine learning techniques. Then, those prediction models are used to identify “unexplained variances” that exist in the historical data, but are absent in the prediction models. Thus, when generating “initial” prediction data for a future time window, the “unexplained variance data” may be reintroduced to generate more accurate “final” prediction data. Additionally, in one or more embodiments, competing prediction models may be utilized to generate multiple sets of prediction data, of which, a most likely/accurate prediction dataset may be chosen (e.g., depending on the variable(s) being forecast).

Lastly, much of the process of generating the prediction data and forecast may be automated. Automating the process ensures that the results are (i) more accurate as there is less room for user error to be introduced during manual curation, (ii) more comprehensive as additional and larger historical datasets may be used, and (iii) less expensive to produce as less time, energy, and resources are expended to produce the prediction data.

Specific embodiments will now be described with reference to the accompanying figures. In the following description, numerous details are set forth as examples. One of ordinary skill in the art, having the benefit of this detailed description, would appreciate that one or more embodiments may be practiced without these specific details and that numerous variations or modifications may be possible without departing from the scope. Certain details, known to those of ordinary skill in the art, may be omitted to avoid obscuring the description.

In the following description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments, any description of any component of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the term ‘operatively connected’, or ‘operative connection’, means that there exists between elements/components/devices a direct or indirect connection that allows the elements to interact with one another in some way (e.g., via the exchange of information). For example, the phrase ‘operatively connected’ may refer to any direct (e.g., wired connection or wireless connection directly between two devices) or indirect (e.g., wired and/or wireless connections between any number of devices connecting the operatively connected devices) connection.

As used herein, the adjectives “source”, “destination”, and “intermediate” are for explanatory purposes only. That is, the components, devices, and collections of devices described using these adjectives are meant only to provide a better understanding to the reader in the context of a particular scenario—not to generally limit the capabilities of those components, devices, and collections of devices. As an example, a “component” may perform certain operations when acting as a “source component” and may perform some of the same and other operations when acting as a “destination component”. However, each “component” (whether it be “source” or “destination”) may be fully capable of performing the operations of either role.

As used herein, the word “data” is treated as an “uncountable” singular noun—not as the plural form of the singular noun “datum”. Accordingly, throughout the application, “data” is paired with a singular verb when written (e.g., “data is”). However, this usage should not be interpreted to redefine “data” to exclusively mean a single bit of information. Rather, as used herein, “data” means any one or more bit(s) of information that are logically and/or physically grouped. Further, “data” may be used as a plural noun if context provides the existence of multiple “data” (e.g., “two data are combined”).

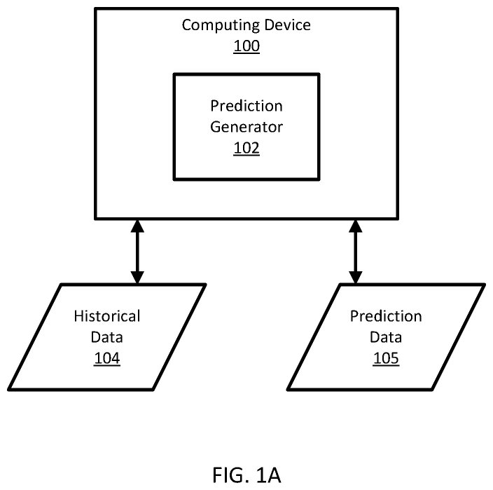

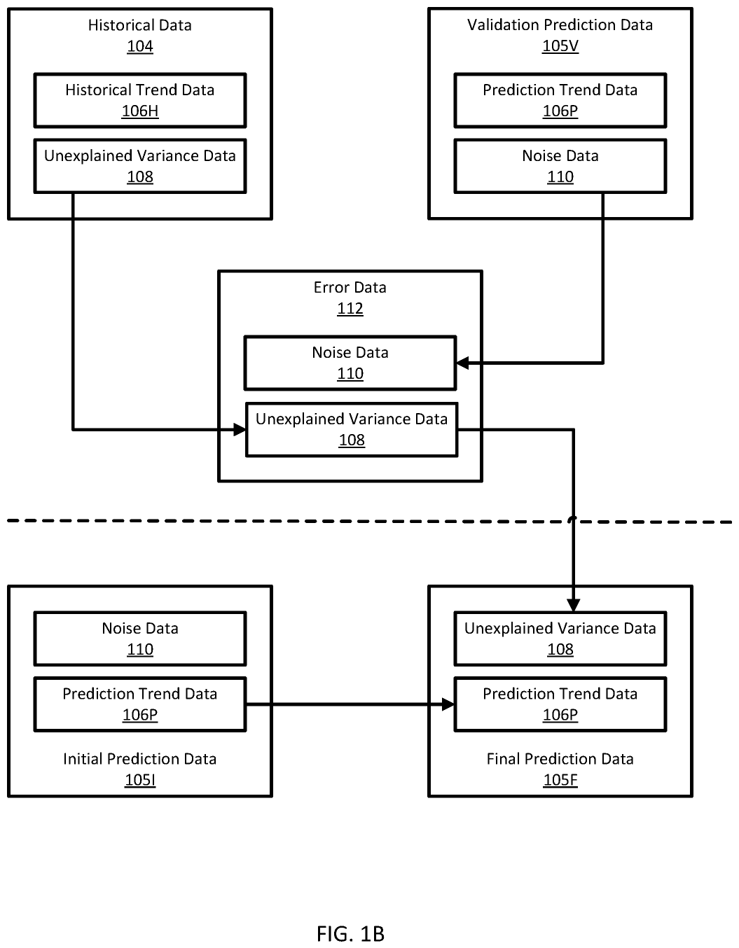

FIG. 1A shows a diagram of a system, in accordance with one or more embodiments. The system may include a computing device (e.g., computing device (100)), a prediction generator (e.g., prediction generator (102)), historical data (e.g., historical data (104)), and prediction data (e.g., prediction data (105)). Each of these components is described below.

In one or more embodiments, a computing device (100) is hardware that includes one or more processor(s), memory (volatile and/or non-volatile), persistent storage, internal physical interface(s) (e.g., serial advanced technology attachment (SATA) ports, peripheral component interconnect (PCI) ports, M.2 ports, etc.), external physical interface(s) (e.g., universal serial bus (USB) ports, recommended standard (RS) serial ports, audio/visual ports, etc.), communication interface(s) (e.g., network ports, small form-factor pluggable (SFP) ports, wireless network devices, etc.), input and output device(s) (e.g., human interface devices), or any combination thereof. Further, in one or more embodiments, the persistent storage (and/or memory) of the computing device (100) may store computer instructions (e.g., computer code) which, when executed by the processor(s) of the computing device (e.g., as software), cause the computing device (100) to perform one or more processes specified in the computer instructions. Non-limiting examples of a computing device (100) include a network device (e.g., switch, router, multi-layer switch, etc.), a server (e.g., a blade-server in a blade-server chassis, a rack server in a rack, etc.), a personal computer (e.g., desktop, laptop, tablet, smart phone, personal digital assistant), and/or any other type of computing device with the aforementioned capabilities.

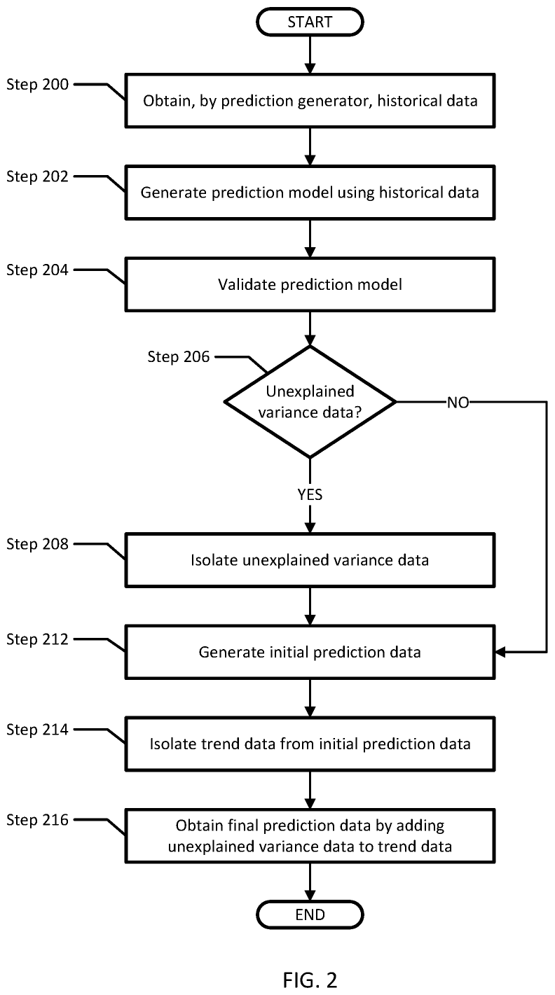

In one or more embodiments, a prediction generator (102) is software, executing on a computing device (100), that is configured to generate (i.e., create, write), maintain, and/or otherwise modify prediction data (105). A prediction generator (102) may perform some or all of the method shown in FIG. 2. In one or more embodiments, a prediction generator may be referred to as an “ensemble online demand generation forecaster”.

In one or more embodiments, data (e.g., historical data (104), prediction data (105)) is digital information stored on a computing device (i.e., in a storage device and/or in memory) (e.g., on computing device (100) or another computing device (not shown) operatively connected to computing device (100)). In one or more embodiments, data may include one or more individual data components (e.g., blocks, files, records, chunks, etc.) that may be separately read, copied, erased, and/or otherwise modified. One of ordinary skill in the art, having the benefit of this detailed description, would appreciate what data is and how data is used on computing devices. Additional details regarding the historical data (104) and prediction data (105) may be found in the description of FIG. 1B.

FIG. 1B shows a diagram of various data, in accordance with one or more embodiments. The types of various data include historical data (e.g., historical data (104)), prediction data (e.g., validation prediction data (105V), initial prediction data (105I), final prediction data (105F)), and error data (112). Each of these components is described below.

In one or more embodiments, historical data (104) is data that includes information that was recorded and collected from past events. In one or more embodiments, each piece of information in the historical data (104) is associated with a specific time (i.e., includes a timestamp) and may be organized into groups based on the type of information or based on a time range (in which the timestamp resides). Historical data (104) may take the form of “time series” data that repeats measurements/records of the same/similar data over time. In the context of business and marketing, and for any specific time period, non-limiting examples of historical data (104) include number of customer visits to a website, cost of advertising (per platform), types of advertising (method, date/time, etc.), cost-per-click (CPC), conversion rates (CV), source of customers (redirecting websites, social media platforms, affiliate links, etc.), number of items sold/shipped/paid for, and/or any other data that may be collected, measured, or calculated for business purposes.

In one or more embodiments, historical data (104) may include historical trend data (106H) and unexplained variance data (108). However, although historical trend data (106H) and unexplained variance data (108) are shown separately in FIG. 1B, historical data (104) may not be readily separable into those components. Rather, as explained in further detail below, historical trend data (106H) is data that includes an identifiable pattern and trend that may be artificially matched to prediction trend data (106P). Consequently, unexplained variance data (108) is other data in the historical data (104) that cannot be approximated by the prediction trend data (106P). Accordingly, as a non-limiting example, if the historical data (104) were manually inspected, one may find “sales records” with no indication of which records (or parts of records) are considered part of the historical trend data (106H) or unexplained variance data (108).

In one or more embodiments, prediction data (105), generally, includes the same information as the historical data (104), except that instead of being recorded from actual events, prediction data (105) is generated by the prediction engine using a prediction model. Further, like historical data (104), the components of prediction data (105) shown in FIG. 1B would not be apparent if the data was inspected manually.

In one or more embodiments, when generated by the prediction engine, prediction data (105) may include two data parts—prediction trend data (106P) and noise data (110) (i.e., as shown in validation prediction data (105V) and initial prediction data (105I)). However, prediction data (105) may be modified to remove (i.e., subtract) the noise data (110) and/or add (i.e., sum) unexplained variance data (108) (i.e., as shown in final prediction data (105F)). Further, prediction data (105) may additionally include metadata (not shown) that includes a margin-or-error (e.g., a range of acceptable prediction data) and/or confidence interval. That is, in one or more embodiments, the prediction data (105) is not an exact prediction of unknown (e.g., future) events, but instead, the prediction data (105) is a calculated approximation of events (with a likely error range).

In one or more embodiments, trend data (106) is data that includes an identifiable pattern (recognizable by computer and/or human) when plotted over time. Trend data (106) may generally be considered “smoother” when plotted alone than when plotted in combination with unexplained variance data (108) and/or noise data (110). Trend data (106) may repeat in cycles (i.e., seasonal data) or may correlate to factors unrelated to time. In one or more embodiments, for the validation prediction data (105V), the prediction trend data (106P) is defined as identical (e.g., accurate, overlapping) data that matches the historical trend data (106H).

In one or more embodiments, error data (112) is the difference in data between the historical data (104) and the validation prediction data (105V). In one or more embodiments, the prediction engine (after generating an accurate prediction model) generates validation prediction data (105V) that accurately represents the historical data (104). Thus, when compared (e.g., by calculating the difference, subtracting one from the other), the trend data (106) cancels out (i.e., the historical trend data (106H) and the prediction trend data (106P)) leaving the error data (112) (which does not include any trend data (106)). The error data (112) may include noise data (110), unexplained variance data (108), and/or any other non-trend data from the historical data (104) or validation prediction data (105V).

In one or more embodiments, unexplained variance data (108) is data that may include patterns, trends, signals, and/or any other information that may be identified beyond the noise data (110) in the error data (112). That is, unexplained variance data (108) may be isolated by eliminating the noise data (110) within the error data (112). In one or more embodiments, the unexplained variance data (108) includes some signal that is likely indicating the existence of one or more predictor variable(s) (e.g., market factors, product pricing, seasonality, trends, market conditions, key performance indicator(s), etc.) that influence the historical data (104), but are absent in the trend data (106) (i.e., the prediction model does not account for those variables). Accordingly, the prediction trend data (106P) (generated using prediction model) is missing some identifiable signal in the historical data (104) (i.e., the unexplained variance data (108)). Accordingly, prediction data (105) may be made more accurate by adding (i.e., summing it with) unexplained variance data (108) prior to its use in a forecast (i.e., the final prediction data (105F)).

Conversely, in one or more embodiments, noise data (110) is data without recognizable patterns, trends, and/or signals. Noise data (110) may appear “random” and may not be efficiently compressed. As a non-limiting example, noise data (110) is the data that would remain in the error data (112) after the unexplained variance data (108) is removed (i.e., subtracted).

As explained in more detail in the description of FIG. 2, the unexplained variance data (108) may be isolated from the error data (112) and stored for additional prediction model training and/or for use in generating the final prediction data (105F). Further, when initial prediction data (105I) is generated for a forecast (of which there is no historical data counterpart), the noise data (110) may be removed, and the unexplained variance data (108) may be added to generate the final prediction data (105F).

FIG. 2 shows a flowchart of generating prediction data, in accordance with one or more embodiments. All or a portion of the method shown may be performed by one or more components of the prediction generator. However, another component of the system may perform this method. While the various steps in this flowchart are presented and described sequentially, one of ordinary skill in the relevant art will appreciate that some or all of the steps may be executed in different orders, may be combined or omitted, and some or all steps may be executed in parallel.

In Step 200, the prediction generator obtains the historical data. The prediction generator may obtain the historical data from the computing device on which the prediction generator is executing or from another computing device operatively connected to the prediction generator.

In Step 202, the prediction generator generates (“trains”) a prediction model using the historical data. In one or more embodiments, the prediction generator uses one or more machine learning algorithm(s) to generate a non-parameterized (e.g., idealized) prediction model or a parametrized prediction model (e.g., requiring input variables). The machine learning models may be generated using continuous time periods (e.g., the most recent five years) and/or using discontinuous seasonal time periods (e.g., each Monday of the past month, each February of the past ten years, spring season, etc.). Non-limiting examples of machine learning methods and techniques that may be used include a random forest algorithm, multilayer perceptron (MLP), one or more neural network(s) (NN) (e.g., convolutional (CNN), forward (FNN), probabilistic (PNN), artificial (ANN), etc.), and/or any other machine learning technique that may be useful for generating a prediction model.

In Step 204, the prediction generator validates the prediction model. In one or more embodiments, validating the prediction model may include using the historical data to grade the accuracy of the training models (i.e., to produce a quantitative score). One method for validating a prediction model is to designate some portion of the historical data as “training data” (from which the prediction model is generated at Step 202) and designate the other portion of the historical data as “test data”. Then, the prediction model is used to generate “validation prediction data” meant to predict the “test data” (the historical data not used to train the prediction model). The “test data” is then compared against (i.e., differenced) the “validation prediction data” to determine how accurate the prediction model is at generating prediction data (generally). To quantitatively measure the accuracy of the prediction model, the difference between the “validation prediction data” and the “test data” may be calculated to produce an error (i.e., the lower the difference, the lower the error, the more accurate the prediction model). One of ordinary skill in the art, given the benefit of this detailed description, would appreciate one or more methods for validating a prediction model produced by a machine learning algorithm. Further, although not shown in FIG. 2, if the prediction model generates inaccurate prediction data (above some error threshold), the prediction model may be modified and validated again (repeating Step 202 and Step 204, potentially through millions of iterations) until a prediction model is produced that generates sufficiently accurate prediction data.

In Step 206, the prediction generator makes a determination as to whether the prediction model produces unexplained variance data. In one or more embodiments, unexplained variance data is a portion of the error data (i.e., the difference between the prediction data and the historical data) that is more than just noise data (i.e., meaningless variations in expected data with no discernable pattern). That is, unexplained variance data may include patterns, trends, signals, and/or any other information that may be identified beyond the noise data in the error data.

In one or more embodiments, the existence of unexplained variance data may be identified by performing one or more statistical operation(s) on the error data. As a non-limiting example, if the average (i.e., mean) of purely noise data is calculated, a value relatively close to 0 should be produced (indicating the noise fluctuates above and below the signal fairly evenly). Accordingly, if the average of the error data (as a whole) is a statistically significant distance from 0, it may be determined that the error data includes more than just noise (i.e., the error data includes unexplained variance data). As another non-limiting example, if a histogram of the error data is produced, a normal distribution should be apparent. However, if the histogram does not follow a normal distribution (e.g., skewing, unstable, bimodal, etc.), it may be determined that the error data includes unexplained variance data.

If the prediction generator determines that the prediction model includes unexplained variance data (Step 206-YES), the process proceeds to Step 208. However, if the prediction generator determines that the models do not include training errors (Step 206-NO), the method proceeds to Step 212.

In Step 208, the prediction generator isolates (e.g., “decomposes”, “separates”, “parses”) the unexplained variance data from the error data (and the noise data thereof). In one or more embodiments, unexplained variance data may be isolated using one or more statistical technique(s). As a non-limiting example, a “smoothing” (exponential smooth, moving average, etc.) operation may be performed on the error data to eliminate the noise data (leaving the unexplained variance data). Further, once parsed, the isolation of the unexplained variance data may be verified by performing the method described in Step 206 on the remaining noise data (the error data minus the unexplained variance data) (e.g., calculating the average and/or generating a histogram of the noise data to confirm the absence of unexplained variance data). In one or more embodiments, ranges of potential noise data may be intelligently identified and removed to isolate the unexplained variance data. One of ordinary skill in the art, given the benefit of this detailed description, would appreciate one or more methods for removing noise data from signal data, generally.

In Step 212, the prediction generator generates “initial prediction data” using the training models for a future time period (i.e., a time period for which there is no historical data). In one or more embodiments, the initial prediction data may be generated based solely on the models trained (at Step 202) independent of the validation results (in Step 204) and the unexplained variance data (in Step 208). In one or more embodiments, the prediction model may be retrained (after Step 204, but before Step 212) using the unexplained variance data to generate a more accurate prediction model.

In Step 214, the prediction generator isolates (e.g., “decomposes”, “separates”, “parses”) the trend data from the initial prediction data to eliminate the error data of the initial prediction data. The initial prediction data, like the validation prediction data generated in Step 204, may include some error data. However, the method previously used to isolate the error data (subtracting the actual historical data in Step 204 and Step 206) is not possible for prediction data generated for a future forecast (as historical data exists for that time period does not exist).

Accordingly, in one or more embodiments, the prediction generator isolates the prediction trend data from the initial prediction data using one or more statistical method(s). Non-limiting examples of statistical methods to isolate trend data include an autoregressive (integrated) moving average (AR(I)MA) algorithm, an error trend and seasonality (ETS) algorithm, Holt-Winters, exponential smooth (ES), TBATS (trigonometric seasonality, box-cox transformation, ARMA errors, trend, seasonal components), and/or any other method to extract and/or isolate the prediction trend data. In one or more embodiments, the prediction generator identifies a generalized pattern in the initial prediction data that is also present in the historical data over the same seasonal time period (e.g., the same day of each week, the same month of one or more previous year(s), over the course of an entire year, etc.). Once identified, a “best fit” match may be made against the initial prediction data to isolate the prediction trend data from the noise data. Further, once isolated, the noise data (i.e., whatever initial prediction data remains after extracting the prediction trend data) may be removed, deleted, and/or otherwise ignored.

In Step 216, the prediction generator obtains the final prediction data by adding (i.e., summing) the unexplained variance data (if applicable, as isolated in Step 208) to the prediction trend data (isolated in Step 214). As discussed in Step 208, error data may include noise data and unexplained variance data. While the noise data may be ignored and removed, the unexplained variance data provides for more accurate prediction data-as there may exist some other key variables and/or market forces that influence the historical data (and future events) that are not present in the trend data. Accordingly, the final prediction data includes, at least, the prediction trend data (data for which there is some identifiable curve) in addition to unexplained variance data (data for which the underlying cause is unknown).

In one or more embodiments, the final prediction data may include a range (i.e., a margin of error) that the actual future data may fall within (e.g., a confidence interval). Thus, the accuracy of the final prediction data is improved by including the unexplained variance data (found while training the models) that would not have been included had the final prediction data been generated manually.

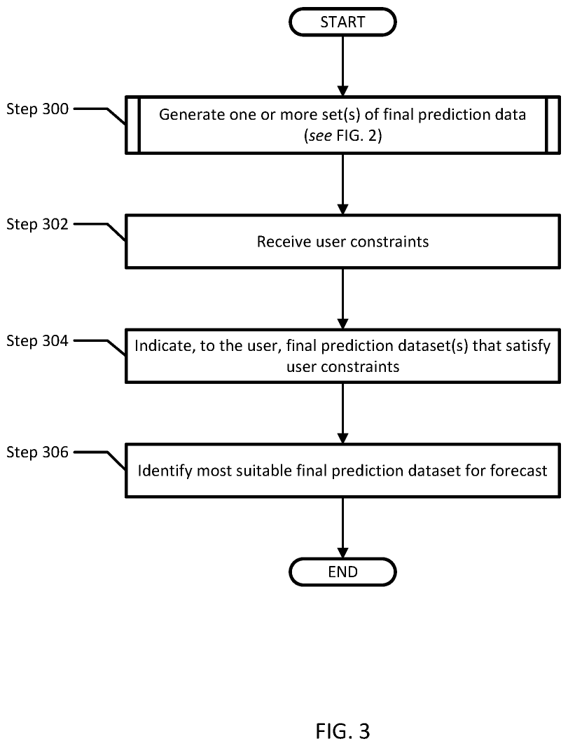

FIG. 3 shows a flowchart of identifying a most suitable final prediction dataset, in accordance with one or more embodiments. All or a portion of the method shown may be performed by one or more components of the prediction generator. However, another component of the system may perform this method. While the various steps in this flowchart are presented and described sequentially, one of ordinary skill in the relevant art will appreciate that some or all of the steps may be executed in different orders, may be combined or omitted, and some or all steps may be executed in parallel.

In Step 300, the prediction generator generates (and/or otherwise obtains) one or more sets of final prediction data (see FIG. 2). Each of the sets of final prediction data may be generated using different prediction models (e.g., using different machine learning techniques), using different portions of the historical data (e.g., sales data, advertising cost data, website visit data, etc.), needing different variables, etc. Hereinafter, multiple sets of “final prediction data” will be referred to as “final prediction datasets”.

In Step 302, the prediction generator receives one or more constraint(s) from a user (i.e., “user constraint(s)”, “constraint(s)”). Non-limiting examples of constraints include product listing advertisement (PLA) costs, website banner costs, affiliate costs, social media advertising costs, corporate social responsibility costs, revenue, product sales, website visits, and/or any other data that may be available in the historical data and/or prediction data.

In Step 304, the prediction generator indicates all final prediction datasets that satisfy the user constraint(s). The prediction generator may indicate the matching results (e.g., by highlighting each final prediction dataset that satisfies the user constraint(s)), provide a list of only the final prediction datasets that satisfy the user constraint(s), and/or provide any other indication (visual or otherwise) of which final prediction datasets satisfy the user constraint(s).

Conversely, if the prediction generator determines that a final prediction dataset does not satisfy the user constraint(s), the prediction generator may provide a different indicator that the final prediction dataset does not match (e.g., a red X mar, red highlighting, etc.).

In Step 306, the prediction generator identifies a most suitable final prediction dataset for the user to be used in a forecast. The prediction generator may identify the most suitable final prediction dataset by using one or more statistical methods (e.g., mean absolute percent error (MAPE), Akaike information criterion (AIC), etc.). Once identified, the most suitable final prediction dataset may be provided (and/or otherwise indicated) to the user.

While one or more embodiments have been described herein with respect to a limited number of embodiments and examples, one of ordinary skill in the art, having the benefit of this detailed description, would appreciate that other embodiments can be devised which do not depart from the scope of the embodiments disclosed herein. Accordingly, the scope should be limited only by the attached claims.

What is claimed is:

1. A method for generating final prediction data, comprising:
generating, by a prediction generator, validation prediction data using a prediction model;
making a first determination that the validation prediction data comprises unexplained variance data;
in response to making the first determination:
isolating unexplained variance data from the validation prediction data;
generating initial prediction data using the prediction model;
isolating prediction trend data from the initial prediction data; and
obtaining the final prediction data by summing the prediction trend data with the unexplained variance data.

2. The method of claim 1, wherein prior to generating the validation prediction data, the method further comprises:
obtaining historical data; and
generating the prediction model using the historical data.

3. The method of claim 2, wherein generating the prediction model comprises:
training the prediction model using the historical data.

4. The method of claim 1, wherein after obtaining the final prediction data, the method further comprises:
receiving, from a user, a constraint;
making a second determination that the final prediction data satisfies the constraint; and
based on the second determination:
indicating, to the user, that the final prediction data satisfies the constraint.

5. The method of claim 1, wherein after obtaining the final prediction data, the method further comprises:
receiving, from a user, a constraint;
making a second determination that the final prediction data does not satisfy the constraint; and
based on the second determination:
indicating, to the user, that the final prediction data does not satisfy the constraint;
obtaining second final prediction data;
making a third determination that the second final prediction data satisfies the constraint; and
based on the third determination:
indicating, to the user, that the second final prediction data satisfies the constraint.

6. The method of claim 1, wherein isolating the prediction trend data from the initial prediction data comprises:
using an autoregressive integrated moving average (ARIMA) model to identify the prediction trend data.

7. The method of claim 1, wherein isolating the unexplained variance data from the validation prediction data comprises:
using a smoothing algorithm to remove noise data from the validation prediction data.

8. A non-transitory computer readable medium comprising instructions which, when executed by a computer processor, enables the computer processor to perform a method for generating final prediction data, comprising:
generating, by a prediction generator, validation prediction data using a prediction model;
making a first determination that the validation prediction data comprises unexplained variance data;
in response to making the first determination:
isolating unexplained variance data from the validation prediction data;
generating initial prediction data using the prediction model;
isolating prediction trend data from the initial prediction data; and
obtaining the final prediction data by summing the prediction trend data with the unexplained variance data.

9. The non-transitory computer readable medium of claim 8, wherein prior to generating the validation prediction data, the method further comprises:
obtaining historical data; and
generating the prediction model using the historical data.

10. The non-transitory computer readable medium of claim 9, wherein generating the prediction model comprises:
training the prediction model using the historical data.

11. The non-transitory computer readable medium of claim 8, wherein after obtaining the final prediction data, the method further comprises:
receiving, from a user, a constraint;
making a second determination that the final prediction data satisfies the constraint; and
based on the second determination:
indicating, to the user, that the final prediction data satisfies the constraint.

12. The non-transitory computer readable medium of claim 8, wherein after obtaining the final prediction data, the method further comprises:
receiving, from a user, a constraint;
making a second determination that the final prediction data does not satisfy the constraint; and
based on the second determination:
indicating, to the user, that the final prediction data does not satisfy the constraint;
obtaining second final prediction data;
making a third determination that the second final prediction data satisfies the constraint; and
based on the third determination:
indicating, to the user, that the second final prediction data satisfies the constraint.

13. The non-transitory computer readable medium of claim 8, wherein isolating the prediction trend data from the initial prediction data comprises:
using an autoregressive integrated moving average (ARIMA) model to identify the prediction trend data.

14. The method of claim 1, wherein isolating the unexplained variance data from the validation prediction data comprises:
using a smoothing algorithm to remove noise data from the validation prediction data.

15. A computing device, comprising:
memory; and
a processor executing a prediction generator, wherein the processor is configured to perform a method for generating final prediction data, comprising:
generating, by a prediction generator, validation prediction data using a prediction model;
making a first determination that the validation prediction data comprises unexplained variance data;
in response to making the first determination:
isolating unexplained variance data from the validation prediction data;
generating initial prediction data using the prediction model;
isolating prediction trend data from the initial prediction data; and
obtaining the final prediction data by summing the prediction trend data with the unexplained variance data.

16. The computing device of claim 15, wherein prior to generating the validation prediction data, the method further comprises:
obtaining historical data; and
generating the prediction model using the historical data.

17. The computing device of claim 16, wherein generating the prediction model comprises:
training the prediction model using the historical data.

18. The computing device of claim 15, wherein after obtaining the final prediction data, the method further comprises:
receiving, from a user, a constraint;
making a second determination that the final prediction data satisfies the constraint; and
based on the second determination:
indicating, to the user, that the final prediction data satisfies the constraint.

19. The computing device of claim 15, wherein after obtaining the final prediction data, the method further comprises:
receiving, from a user, a constraint;
making a second determination that the final prediction data does not satisfy the constraint; and
based on the second determination:
indicating, to the user, that the final prediction data does not satisfy the constraint;
obtaining second final prediction data;
making a third determination that the second final prediction data satisfies the constraint; and
based on the third determination:
indicating, to the user, that the second final prediction data satisfies the constraint.

20. The computing device of claim 15, wherein isolating the prediction trend data from the initial prediction data comprises:
using an autoregressive integrated moving average (ARIMA) model to identify the prediction trend data.
